(19) United States
(12) Patent Application Publication
(10) Pub. No.: US 2025/0375273 A1
(43) Pub. Date: Dec. 11, 2025

(54) METHOD OF PRODUCING A DENTAL OBJECT

(71) Applicant: Ivoclar Vivadent AG, Schaan (LI)

(72) Inventors: Nicola BITAR, Montlingen (CH); Jonas REINHARDT, Igis (CH); Christian RITZBERGER, Grabs (CH); Andreas SCHÜLKE, Grabs (CH)

(21) Appl. No.: 19/231,821

(22) Filed: Jun. 9, 2025

(30) Foreign Application Priority Data
Jun. 10, 2024 (EP) 24181171.0

(51) Int. Cl. A61C 13/00; A61C 13/09

(52) U.S. Cl. CPC A61C 13/0004; A61C 13/0019; A61C 13/09

(57) ABSTRACT

A method of producing a dental object, including the steps of printing (S101) a substructure; printing (S102) an intermediate layer from a support material on the substructure; and printing (S103) the dental object from the production material for the dental object on the intermediate layer.

### CROSS-REFERENCE TO RELATED APPLICATIONS

This application claims priority to European patent application No. 24181171.0 filed on Jun. 10, 2024, which disclosure is incorporated herein by reference in its entirety.

### TECHNICAL FIELD

The present invention relates to a method of producing a dental object and to a printer for producing the dental object.

### SUMMARY

In three-dimensional printing (3D printing), a component can easily be damaged by subsequent processing steps. This is the case, for example, if the component is removed from the build platform of the printer and further processing steps are then carried out manually. For example, the surface is reworked so that the roughness can be minimized. If the component is polished in an unsintered state, mechanical damage to the component can occur. Cracks can occur, so that insufficient strength is achieved after sintering. US2023225830 and US 2023255729 are directed to orthodontic devices and are hereby incorporated by reference in their entirety.

When debinding and sintering the component, the problem arises that the component distorts, as the contact surface is unevenly distributed and deformations of the component occur. Delicate components are therefore generally difficult to process by hand as they are fragile in the green state. The components generally have poor mechanical properties in the unsintered state.

Impression material or kits are normally used for subsequent processing so that the produced component can be reworked. For example, bars created during milling or supports created during 3D printing are removed.

It is the technical task of the present invention to simplify the production of a dental object by means of 3D printing.

This technical task is solved by subject-matter according to the independent claims. Technically advantageous embodiments are the subject-matter of the dependent claims, the description and the drawings.

According to a first aspect, the technical task is solved by a method of producing a dental object, comprising the steps of printing a substructure; printing an intermediate layer from a support material on the substructure; and printing the dental object from the production material for the dental object on the intermediate layer. This method makes it possible to produce thinner dental objects, such as ultra-thin veneers. Reworking can be significantly improved due to the previously printed substructure on which the dental object rests.

In a technically advantageous embodiment of the method, the production material for the dental object comprises an oxide ceramic material. This achieves the technical advantage, for example, that a particularly suitable production material is used.

In a further technically advantageous embodiment of the method, the support material comprises a water-soluble support material, a wax and/or a non-ionic surfactant. This achieves the technical advantage, for example, that a particularly suitable support material is used.

In a further technically advantageous embodiment of the method, a thickness of the intermediate layer is 0.05 mm to 2 mm. This achieves the technical advantage, for example, that a good fit is achieved between the dental object and the substructure.

In a further technically advantageous embodiment of the method, a shape of a recess in the dental object corresponds to the shape of the substructure. This achieves the technical advantage, for example, that a large contact surface is created between the dental object and the substructure.

In a further technically advantageous embodiment of the method, the substructure is printed with an inner cavity. This achieves the technical advantage, for example, that material can be saved for constructing the substructure.

In a further technically advantageous embodiment of the method, the cavity of the substructure is filled with support material. This achieves the technical advantage, for example, of increasing the strength of the hollow substructure.

In a further technically advantageous embodiment of the method, a thickness of the wall of the substructure surrounding the cavity is between 1 mm and 3 mm. This achieves the technical advantage, for example, that the substructure is highly stable.

In a further technically advantageous embodiment of the method, the substructure is printed with a tool interface. This achieves the technical advantage, for example, that handling of the dental object is improved.

In a further technically advantageous embodiment of the method, the substructure is printed from the production material for the dental object. This achieves the technical advantage, for example, that printing can be carried out with a small number of different materials. Furthermore, no additional print head needs to be installed, so that the 3D printer can be produced with less effort.

In a further technically advantageous embodiment of the method, the support material is removed after printing. This achieves the technical advantage, for example, that the dental object can rest positively on the substructure.

In a further technically advantageous embodiment of the method, the support material is melted after printing. This achieves the technical advantage, for example, that the support material can be easily removed.

In a further technically advantageous embodiment of the method, the support material penetrates into the dental object after printing. This achieves the technical advantage, for example, that the strength of the dental object is increased. The support material absorbed in the porous matrix of the production material also makes it easier to grind and polish the dental object, so that a smoother surface can be produced automatically.

In a further technically advantageous embodiment of the method, the dental object is sintered together with the substructure. The dental object can be polished before sintering. This achieves the technical advantage, for example, that sintering distortion or deformation of the dental object during sintering can be reduced.

According to a second aspect, the technical task is solved by a printer for performing the method according to the first aspect. This achieves the same technical advantages as the method according to the first aspect.

According to a third aspect, the technical task is solved by a computer program comprising instructions which, when the computer program is executed by a printer with a control device, cause the printer to execute the method according to the first aspect. This achieves the same technical advantages as the method according to the first aspect.

### BRIEF DESCRIPTION OF THE DRAWINGS

Exemplary embodiments of the invention are shown in the drawings and are described in more detail below, in which:

FIG. 1 shows a schematic view of a printed dental object;

FIG. 2 shows a schematic view of a printed dental object; and

FIG. 3 shows a block diagram of a method of producing a dental object.

### DETAILED DESCRIPTION

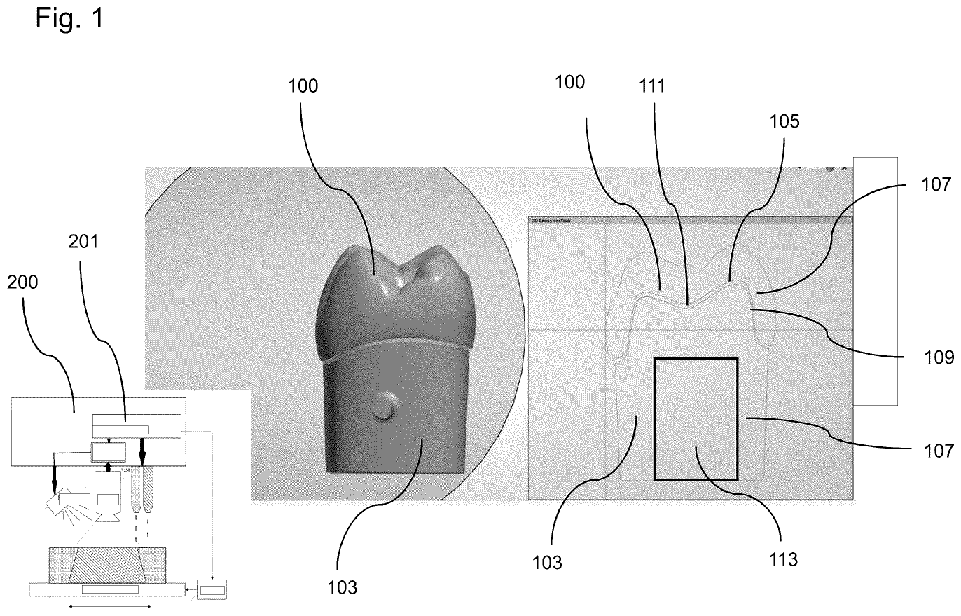

FIG. 1 shows a schematic view of a printed dental object 100 formed by a crown. The dental object 100 is printed layer by layer by means of a three-dimensional printing process using a movable print head. To print the dental object 100 with the substructure 103 and the intermediate layer 105, a 3D printer 200 with an electronic control device 201 can be used, which builds up the individual components layer by layer. The control device 201 comprises a microprocessor for executing a computer program that controls the printer 200 and its components.

A spatially adapted substructure 103 is printed under the dental object 100. This printed substructure 103 is printed from the same production material 107 as the dental object 100. Alternatively, a different material can be used for printing the substructure 103.

The substructure 103 may have the shape of a remaining stump-shaped portion of a natural tooth after it has been damaged or treated to make room for a dental crown, bridge or other dental prosthesis. The remaining tooth serves as a base for the new dental prosthesis to be placed over it. The function of the remaining tooth is to provide a stable and firm base for the dental prosthesis while restoring the natural aesthetics and function of the set of teeth. The dentist or dental technician shapes and prepares the remaining tooth so that the dental prosthesis can be securely placed on it.

A thin intermediate layer made of a support material 109 is printed between the dental object 100 and the substructure 103. The thickness of the intermediate layer is, for example, 0.05 mm to 2 mm and can subsequently be removed. The support material 109 is, for example, a water-soluble support material, a wax and/or a non-ionic surfactant. The substructure 103 can be printed with an inner cavity 113, which is also filled with support material.

Depending on their origin, waxes are divided into three main groups, namely natural waxes, chemically modified waxes and synthetic waxes. In the case of natural waxes, a distinction is made between vegetable and animal waxes, mineral waxes and petrochemical waxes.

In the present invention, petrochemical waxes, such as kerosene wax (hard kerosene), petrolatum, micro wax (micro kerosene) and mixtures thereof, particularly preferably kerosene wax, are preferably used. Vegetable waxes, such as candelilla wax, carnauba wax, Japan wax, esparto grass wax, cork wax, guaruma wax, rice germ oil wax, sugar cane wax, ouricury wax, montan wax; animal waxes, such as beeswax, shellac wax, spermaceti, lanolin (wool wax), brush grease; mineral waxes, such as ceresin, ozokerite (earth wax); chemically modified waxes, such as montan ester waxes, sasol waxes, hydrogenated jojoba waxes or synthetic waxes such as polyalkylene waxes or polyethylene glycol waxes can be used.

Non-ionic surfactants are, for example, fatty alcohol ethoxylates, fatty alcohol propoxylates, alkyl glucosides, alkyl polyglucosides, octylphenoethoxylates, nonylphenoethoxylates.

Once printing is complete, the support material 109 is removed again. This causes the intermediate space between the dental object 100 and the substructure 103 to shrink. The dental object 100 then rests on the substructure 103 in a form-fitting manner. This has the advantage that the force applied during handling is distributed over the entire contact surface and the mechanical properties are improved. Damage during handling of the dental object 100 can be reduced. This is the case because the dental object 100 has a large contact surface on the substructure 103, so that no point loads occur.

The front of the dental object 100 is usually pre-polished once again so that less time is required for polishing in the sintered state. The polishing time can be reduced by a factor of 4 using this method. The reject rate can be halved. However, these advantages apply to all produced dental objects 100 that are processed or heated again after printing.

The printed substructure 103 is also of great advantage for a firing process, as distortion of the dental object 100 can be minimized. The contact surface is constant and evenly distributed, so that the contact load per square centimeter is reduced. This also reduces distortion during sintering or crystallization, as is the case with lithium disilicate.

The advantage of this method is that no time is lost during printing. It makes no difference in terms of time whether a substructure 103 or support material 109 is printed under the dental object 100. Overall, it does not take longer to print the dental object 100.

A further advantage is that a tool adapter can be printed into the substructure 103 so that accommodation in a tool or engagement of a tool is possible. For this purpose, the substructure 103 comprises, for example, a correspondingly shaped recess as a tool interface. This allows the substructure 103 to be clamped or inserted into a tool so that the dental object 100 can be polished reliably and easily. Reworking in an automated machine is also possible, for example in a CNC machine or a trowalizing polishing machine.

Alternatively, it is also possible to print the substructure 103 hollow on the inside and provide it with a specific wall thickness of 1 mm to 3 mm, for example. This can save production material 107. The resulting cavity can then be printed and filled with support material 109. In order to save material for the substructure 103, the substructure 103 only fills the recess 111 of the dental object 100 and has no additional design height below the dental object 100 in the vertical direction. The substructure 103 improves manual reworking and reduces the sintering distortion of the dental object 100. It is difficult to rework thin dental objects 100 before firing. Without a substructure, certain dental objects 100 cannot be processed as they break during pre-polishing.

This simplifies the production of dental objects 100, such as dental restorations or prostheses, using 3D printing. The intermediate layer 105 serves to prevent sintering distortion and to enable polishing of thin-walled dental objects 100.

The method allows thinner dental objects 100 to be sintered with less sintering distortion. Different material compositions have no influence in this method. The lower sintering distortion is due to the fact that the substructure 103 has the same geometric shape as the dental object 100. This results in a large contact surface with low point loads.

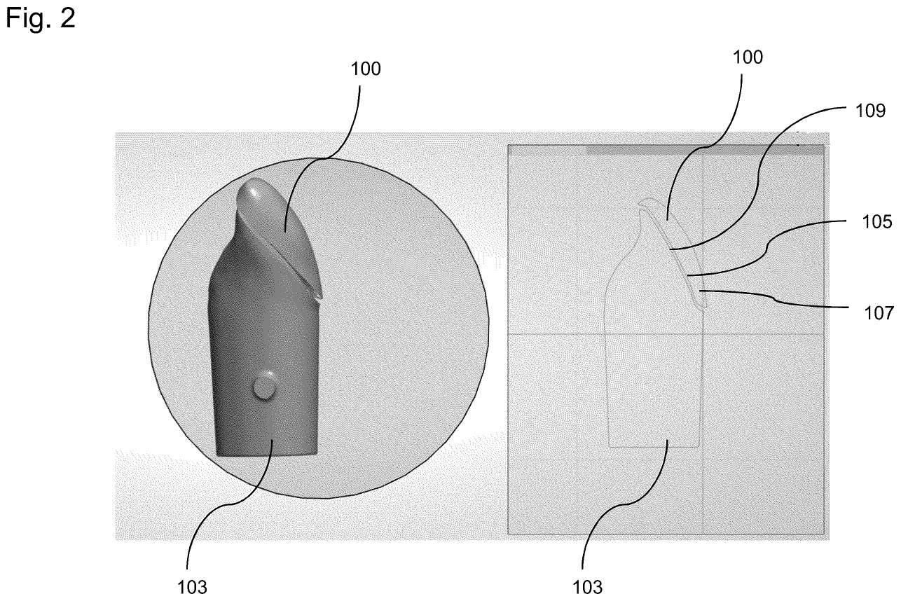

FIG. 2 shows a schematic view of another printed dental object 100, which is formed by a veneer. The dental object 100 can be moved and handled together with the printed substructure 103. The contact surface between the dental object 100 and the substructure 103 allows forces to be transmitted without damaging the dental object 100.

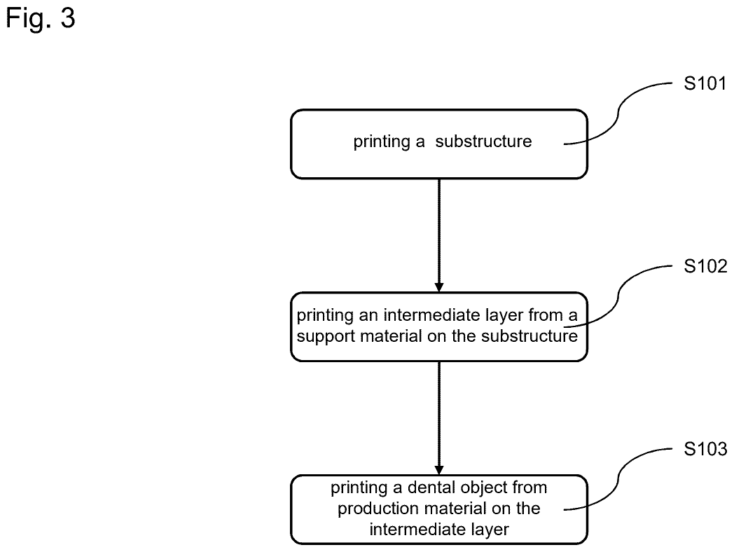

FIG. 3 shows a block diagram of a method of producing the dental object 100. The method comprises the step S101 of printing the substructure 103. In step S102, the intermediate layer 105 is printed from the support material 109 on the substructure 103. In step S103, the dental object 100 is printed from the production material 107 for the dental object 100 on the intermediate layer 105. The individual steps S101 to S103 can be carried out simultaneously as part of layer-by-layer printing.

The method can be used to print thinner and more delicate dental objects 100, which are subsequently easier to handle and polish thanks to the substructure 103. The production of the dental objects 100, such as dental restorations or prostheses, using a 3D printing process is thus simplified and the effort involved is reduced.

All the features explained and shown in connection with individual embodiments of the invention can be provided in different combinations in the subject-matter according to the invention in order to realize their advantageous effects at the same time.

All method steps can be implemented by devices that are suitable for executing the respective method step. All functions performed by the features of the subject-matter can be a method step of a method.

The scope of protection of the present invention is given by the claims and is not limited by the features explained in the description or shown in the figures.

### REFERENCE LIST

100 Dental object
103 Substructure
105 Intermediate layer
107 Production material
109 Support material
111 Recess
113 Cavity
200 Printer
201 Control device

1. A method of producing a dental object, comprising the steps of:
printing a substructure;
printing an intermediate layer from a support material on the substructure; and
printing the dental object from the production material for the dental object on the intermediate layer.

2. The method according to claim 1, wherein the production material for the dental object comprises an oxide ceramic material.

3. The method according to claim 1, wherein the support material comprises a water-soluble support material, a wax and/or a non-ionic surfactant.

4. The method according to claim 1, wherein a thickness of the intermediate layer is 0.05 mm to 2 mm.

5. The method according to claim 1, wherein a shape of a recess in the dental object corresponds to the shape of the substructure.

6. The method according to claim 1, wherein the substructure is printed with an inner cavity.

7. The method according to claim 6, wherein the cavity of the substructure is filled with support material.

8. The method according to claim 6, wherein a thickness of the wall of the substructure surrounding the cavity is between 1 mm and 3 mm.

9. The method according to claim 1, wherein the substructure is printed with a tool interface.

10. The method according to claim 1, wherein the substructure is printed from the production material for the dental object.

11. The method according to claim 1, wherein the support material is removed after printing.

12. The method according to claim 1, wherein the support material is melted after printing.

13. The method according to claim 1, wherein the support material penetrates into the dental object after printing and/or the dental object is sintered together with the substructure.

14. A printer for performing the method of claim 1.

15. A computer program product comprising program code which is stored on a non-transitory machine-readable medium, the machine-readable medium comprising computer instructions executable by a processor of a printer with a control device, which computer instructions cause the processor to perform the method according to claim 1.
